(19) United States
(12) Patent Application Publication
(10) Pub. No.: US 2019/0176511 A1
(43) Pub. Date: Jun. 13, 2019

(54) METHOD OF CREATING AN OLD APPEARANCE FOR ARTWORKS

(71) Applicant: Thomas Pruett, Olive Branch, MS (US)

(72) Inventor: Thomas Pruett, Olive Branch, MS (US)

(21) Appl. No.: 15/841,235

(22) Filed: Dec. 13, 2017

(51) Int. Cl. B44C 5/04

(52) U.S. Cl. CPC B44C 5/0407

(57) ABSTRACT

Methods are disclosed to give an antique appearance to a picture or painting. In one embodiment a tempered glass is sandwiched between a transparent sheet of material and the artwork. Subsequently, the tempered glass is fractured into pieces such that the artwork and the transparent sheet of material are not affected. In some embodiments the tempered glass may be fractured before the transparent sheet of material is placed on it and in other embodiments, such as when a laminated tempered glass is used, there may be no need for a transparent cover sheet of material.

### CROSS-REFERENCE(S) TO RELATED APPLICATION(S)

NONE

### TECHNICAL FIELD

This application relates generally to construction of antique-looking artwork. More specifically, this application relates to a method for creation of crackle effect on artworks.

### BRIEF DESCRIPTION OF THE DRAWINGS

The drawings, when considered in connection with the following description, are presented for the purpose of facilitating an understanding of the subject matter sought to be protected.

FIG. 1 shows an example artwork to be given an antique appearance without any invasive process;

FIG. 2 illustrates an embodiment of the disclosed method;

FIG. 3 shows the artwork of FIG. 1 with a crackled appearance, according to an example method of the present disclosure;

FIG. 4 shows the artwork of FIG. 1 with a shattered appearance, according to another method of the present disclosure; and

FIG. 5 shows a side view of yet another example of the disclosed methods.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

Various methods have been used to give an antique look to new artwork. The results of some of these methods are called crackled finishes, wrinkled finishes, spatter effects, hammer effects, etc. Examples of such (1) methods are submerging an artwork in various chemicals; (2) coating the artwork with special transparent or non-transparent paints; or, (3) in case of a painting, folding the artwork multiple times, etc. One of these methods imitates a crackle effect on the artwork to create an imitation antique with a cracked surface. Different methods have been disclosed to create the appearance of a cracked object, but all such methods physically and permanently affect the artwork.

Sometime the crackle effect is a part of the manufacturing and production of a new object such as crackled ceramics or glasses. Processes have been discloses, for example, to form an imitation antique with cracked painted surface by applying a base coat of specially formulated ingredients, allowing the same to dry, and then applying a different coat of specially formulated ingredients which result in a crackled appearance, producing the illusion of a painted surface in which the paint has cracked due to aging. However, there is a need for a non-invasive method that does not alter the artwork/object in any form.

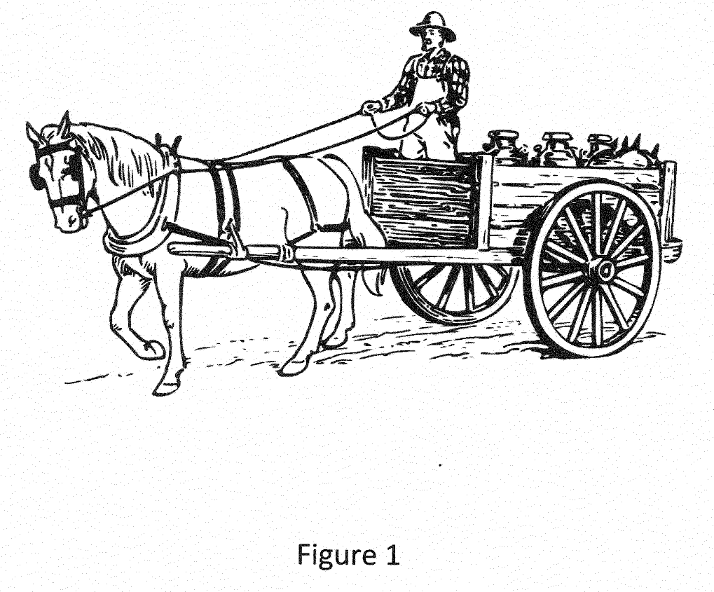

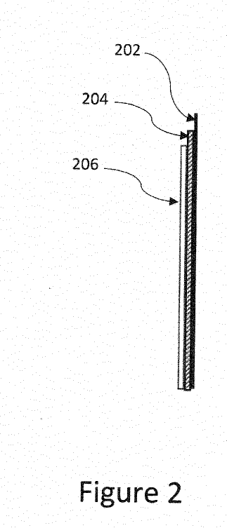

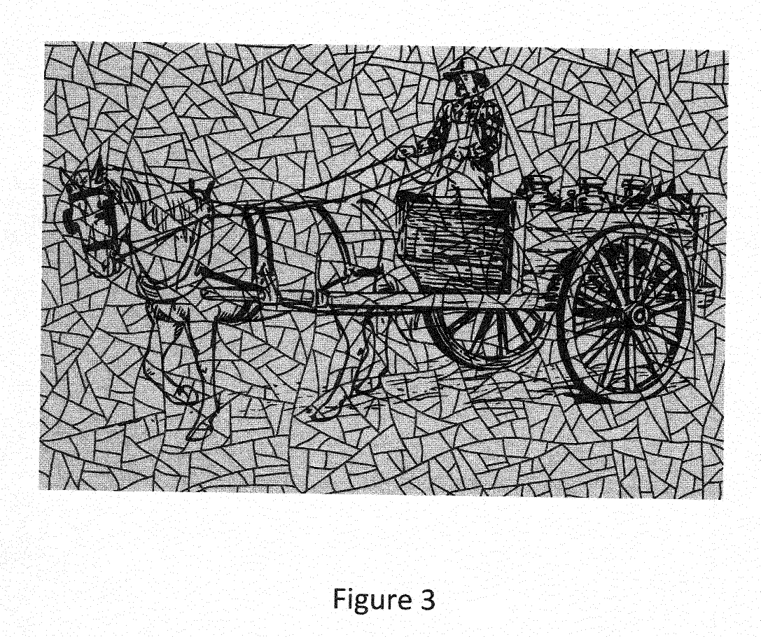

In an embodiment, to create an antique appearance for a picture or painting, such as the painting shown in FIG. 1, a tempered glass—called the “middle sheet”—is sandwiched between a transparent sheet of material—called the “cover sheet”—and the artwork. In various embodiments the tempered glass may be laminated or not. Subsequent to this step, the middle sheet is fractured into pieces by a sharp blow, preferably to its edge, such that the cover sheet and the artwork are not affected or damaged. FIG. 2 illustrates how a tempered glass 204 is sandwiched between the artwork 202 and the transparent sheet 206. FIG. 3 shows the resulting appearance of this method/process after the middle sheet is crackled.

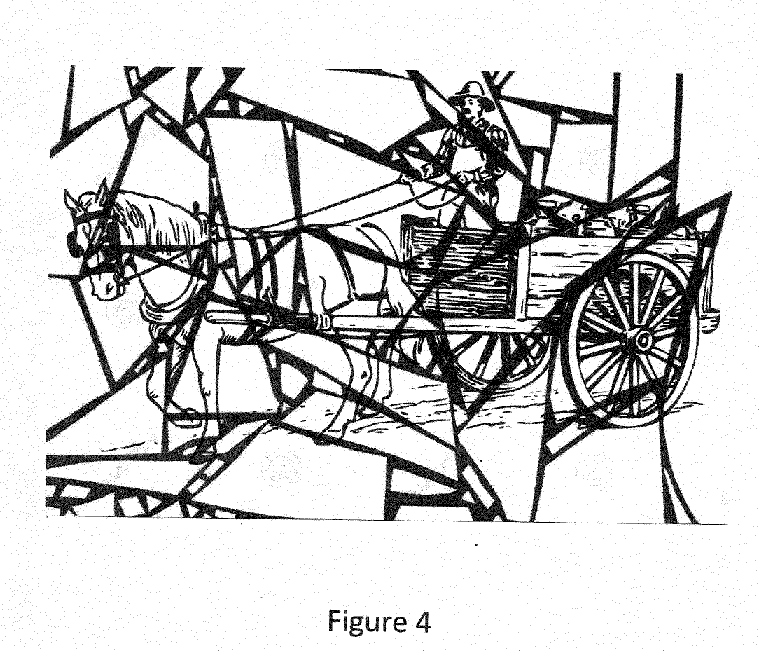

In some embodiments the material between the cover sheet and the picture or painting is any fragile sheet of material such as a non-tempered sheet of glass. In such embodiments, as shown in FIG. 4, the pieces of the broken glass may be larger than those of a tempered glass.

In other embodiments the cover sheet may be comprised of multiple fragile and/or non-fragile transparent sheets of materials, like polymers, with different effects such as blurring the picture or painting.

In some embodiments the sandwiched sheet of fragile material is shattered either by a blow to an edge of the middle sheet or one or more blows to the back surface of the picture or painting. In general a sharp and fast blow to the back of the artwork breaks the middle sheet but will not result in any damage to the cover sheet.

In various embodiments, for a sharp and fast blow, an automatic center punch may be employed to shatter the sheet of fragile material. In such embodiments it is easy to limit the blow to an edge of the middle sheet so that the cover sheet of material is not disturbed. The automatic center punch may be used on an edge of the sandwiched sheet of fragile material or on the back surface of the picture or painting. Such a surface blow will not damage the picture or the painting because the hardness of the middle sheet will not permit the tip of the automatic center punch to penetrate the picture or the painting. In these embodiments a user may choose to give the middle sheet more than one blow on multiple points of the edge and/or the back side.

In some embodiments the adjacent shattered pieces may stay in contact with each other, as illustrated in FIG. 3, and in other embodiments the neighboring shattered pieces may be separated by a small distance, as shown in FIG. 4. In yet other embodiments the cover sheet, the middle sheet, and the artwork may or may not be in physical contact with each other and may be separated by a certain distance.

In various embodiments the transparent sheet of material (the cover sheet) may be a mere coat of Polyurethane or the like. In other embodiments the transparent sheet of material may be a transparent adhesive. In some embodiments if the middle sheet is laminated, a cover sheet may not be needed at all.

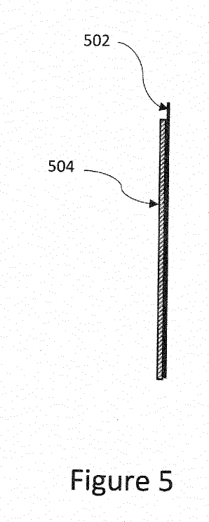

In some embodiments of this method, such as the one illustrated in FIG. 5, a breakable sheet of material 504 such as a tempered or non-tempered glass, may be adhered to the picture or the painting 502 and then be broken so that the pieces of the fragile sheet of material 504 do not scatter. In such embodiments the transparent plate covering the broken sheet can also be eliminated if desired. This particular embodiment of the disclosed methods is intrusive and may affect the artwork.

In yet other embodiments the “middle sheet” may have multiple layers of transparent sheets of materials. In such embodiments more than one fragile sheet of material with different patterns of breaking may be laid over an artwork and several of them may be broken to create a special crack effect over the art. In some embodiments the artwork and the multiple middle sheets of fragile materials may be sold unbroken to provide the buyers with the opportunity to break any of the cover layers as they may desire. In such a case an instruction may be included to inform the buyers about the breaking patterns of each middle layer.

It is important to realize that in this specification the phrase “picture or painting” represents any two or three dimensional artwork or object and the phrase “sheet of material” represents any two or three dimensional sheet.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of creating a crackled look for a picture, painting or an artwork, the method comprising:
placing a sheet of glass (middle sheet) between the picture, painting or the artwork and a transparent sheet of material (cover sheet); and
fracturing the middle sheet.

2. The method of claim 1, wherein the middle sheet is a non-laminated or laminated tempered glass.

3. The method of claim 1, wherein the middle sheet is broken by an automatic center punch.

4. The method of claim 1, further comprising more than one middle sheet.

5. The method of claim 4, wherein at least one middle sheet is non-fragile.

6. The method of claim 1, further comprising more than one cover sheet.

7. The method of claim 1, wherein the cover sheet is fragile.

8. The method of claim 1, wherein the cover sheet is non-fragile.

9. The method of claim 1, wherein the cover sheet is glass or a transparent or semi-transparent polymer.

10. The method of claim 1, wherein the cover sheet is a transparent adhesive.

11. The method of claim 1, wherein the cover sheet is adhered to the middle sheet and/or the middle sheet is adhered to the artwork.

12. The method of claim 1, wherein the middle sheet is not tempered.

13. The method of claim 1, wherein the middle sheets is laminated but not tempered.

14. A method of creating an antique look for an artwork, the method comprising:
mounting a sheet of glass or a fragile transparent material in front of the artwork; and
breaking the glass.

15. The method of claim 14, wherein the glass is a non-laminated tempered glass.

16. The method of claim 14, wherein the glass is a laminated tempered glass.

17. The method of claim 14, further comprising more than one sheet of glass or a fragile transparent material.

18. The method of claim 17, wherein at least one sheet of glass is non-fragile.

19. The method of claim 17, wherein at least one of the glass sheets or fragile transparent sheets is adhered to the artwork.

20. The method of claim 14, wherein the glass sheet or the fragile transparent sheet is broken by multiple blows.
